(19) United States
(12) Patent Application Publication
(10) Pub. No.: US 2025/0206912 A1
(43) Pub. Date: Jun. 26, 2025

(54) COMPOSITIONS COMPRISING POLY(ARYLENE ETHER SULFONES)

(71) Applicant: BASF SE, Ludwigshafen am Rhein (DE)

(72) Inventors: Martin WEBER, Ludwigshafen am Rhein (DE); Carsten HENSCHEL, Hannover (DE); Sebastian STORCK, Ludwigshafen am Rhein (DE); Florian HENNENBERGER, Ludwigshafen am Rhein (DE)

(21) Appl. No.: 18/847,745

(22) PCT Filed: Mar. 10, 2023
(86) PCT No.: PCT/EP2023/056140

§ 371 Date: Sep. 17, 2024

(30) Foreign Application Priority Data
Mar. 18, 2022 (EP) 22162900.9

(51) Int. Cl. C08K 3/04; C08J 3/20; C25B 13/08; H01M 8/0221; H01M 8/0226

(52) U.S. Cl. CPC C08K 3/042; C08J 3/20; C08K 3/04; C25B 13/08; H01M 8/0221; H01M 8/0226; C08J 2381/06; C08K 2201/014

(57) ABSTRACT

The present invention relates to compositions comprising polyarylene(ether)sulfones having high electrical conductivity, good chemical resistance and improved processability suitable to be used in the production of bipolar plates for fuel cells or electrolysis units.

The present invention relates to compositions comprising polyarylene(ether)sulfones having high electrical conductivity, good chemical resistance and improved processability suitable to be used in the production of bipolar plates for fuel cells or electrolysis units.

Bipolar plates are an essential part of fuel cells. They deliver the electrical conductivity to connect the multiple cells in a stack. Furthermore, they provide flow fields for the homogeneous distribution of hydrogen and oxygen to the membrane electrode assembly (MEA). To ensure constant operating temperature, usually a cooling liquid is circulated in the system. Hence, besides the electrical conductivity also the thermal conductivity of the plates is important.

Actually, different materials are used to prepare bipolar plates. While metals deliver excellent mechanical stability and low gas permeability, fabrication of huge numbers of plates is quite challenging. Furthermore, after long operation times the metal plates are subject to corrosion.

Resins filled with high quantities of carbon-based conductive additives like carbon black, graphite, carbon fibers, carbon nanotubes, graphene or others have good conductivity and low gas permeability, but they suffer from poor toughness, which can lead to the breakage of plates either during assembly or during operation of the fuel cell stack.

Also highly filled compounds based on thermoplastic matrices and carbon-based additives are used as material to produce bipolar plates. For fuel cells operated below 80° C. polypropylene-based compounds are sometimes employed, while at elevated operation temperatures polymers with higher modulus at T>80° C. have to be used (R. A. Antunes, J. Power Sources 196, 2011, p. 2945; F. G. B. San, Int. J. Energy Research 37, 2013 p. 283).

PPS (polyphenylenesulfide) is widely used as matrix for highly conductive compounds (S. Radhakrishnan, J. Power Sources 163, 2007 p. 702). Besides the many advantages of PPS, these compounds are quite brittle, and plates produced by such compounds are prone to fracture already during fabrication.

Thus, commonly used polymer materials often show insufficient toughness and insufficient temperature resistance, limiting their applicability in bipolar plates. Therefore, the problem underlying the present invention was to address the deficiencies of known polymer materials and to provide compositions that are particularly suitable for use in bipolar plates. Furthermore, objective of this invention was to deliver new compounds or compositions that can be processed into highly conductive objects showing good mechanical performance, such as plates useful for fuel cell or electrolysis applications, using established processing techniques like injection molding, extrusion or melt pressing.

This problem was solved by the compositions of the present invention. In particular, the present invention provides a composition comprising
A) 15 to 90% by weight of at least one polyarylene(ether)sulfone, having a Viscosity Number of less than 42 ml/g;
B) 5 to 80% by weight of graphite;
C) 5 to 80% by weight of a conductive carbon black;
D) 0 to 25 wt.-% of carbon nanotubes; and
E) 0 to 40% by weight of at least one additive;
wherein the sum of % by weight of the components of the composition is 100% by weight.

Herein, “at least one” may in general mean one or two or more, such as three or four or five or more, wherein more may mean a plurality or an uncountable. For instance, it may mean one or a mixture of two or more. If used in connection with chemical compounds “at least one” is meant in the sense that one or two or more chemical compounds differing in their chemical constitution, that is chemical nature, are described.

Furthermore, herein “polymer” may mean homopolymer or copolymer or a mixture thereof. The person skilled in the art appreciates that any polymer, may it be a homopolymer or a copolymer by nature typically is a mixture of polymeric individuals differing in their constitution such as chain length, degree of branching or nature of endgroups. Thus, in the following “at least one” as prefix to a polymer means that different types of polymers may be encompassed whereby each type may have the difference in constitution addressed above.

The inventive compositions comprise 15 to 90% by weight of at least one polyarylene(ether) sulfone (component A)), having a Viscosity Number (V.N.) of less than 42 ml/g. The Viscosity Number is measured according to ISO 1628 in NMP (N-methyl-2-pyrrolidone) at a concentration of 1 g per 100 ml solution at 25° C. The V.N. is a common parameter in the field of polymers correlating with the molecular weight of the respective material. This parameter is well-known to the person skilled in the art.

Polyarylene(ether)sulfones belong to the group of high temperature resistant polymers showing high heat resistance, excellent mechanical performance and inherent flame retardancy (E. M. Koch, H. M. Walter, Kunststoffe 80 (1990) 1146; E. Döring, Kunststoffe 80, (1990) 1149, N. Inchaurondo-Nehm, Kunststoffe 2008 190). Polyarylene(ether)sulfones are generally known to a person skilled in the art. In principle, for component A) a polyarylene(ether)sulfone of any structure is encompassed by the present invention provided that the polyarylene(ether)sulfone used as component A) has a Viscosity Number of less than 42 ml/g. It may be preferred, if the Viscosity Number of the component A) polyarylene(ether)sulfone is equal to or less than 41 ml/g, specifically equal to or less than 40 ml/g, even more specifically equal to or less than 39 ml/g. According to a specific embodiment, the Viscosity Number of the component A) polyarylene(ether)sulfone is equal to or less than 38 ml/g. According to a further embodiment, the polyarylene(ether)sulfone of component A) shows a Viscosity Number in the range of 38 ml/g to less than 42 ml/g, in particular 38 ml/g to 41 ml/g.

It may be preferred that the polyarylene(ether)sulfone is composed of units of the general formula II

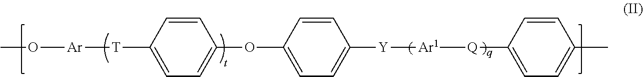

wherein the definitions of the symbols t, q, Q, T, Y, Ar and Ar¹ are as follows:
t, q independently of one another 0, 1, 2 or 3;
Q, T, Y independently of one another a chemical bond or a group selected from —O—, —S—, —SO₂—, S═O, C═O, —N═N— and —CR^{a}R^{b}—, wherein R^{a} and R^{b} independently of one another are a hydrogen atom, (C₁-C₁₂)alkyl, (C₁-C₁₂)alkoxy, (C₃-C₁₂)cycloalkyl or a (C₆-C₁₈)aryl group, and wherein at least one of Q, T, and Y is present and is —SO₂—; and
Ar and Ar¹ independently of one another (C₆-C₁₈)arylene.

If, within the abovementioned preconditions, Q, T or Y is a chemical bond, this means that the adjacent group on the left-hand side and the adjacent group on the right-hand side are present with direct linkage to one another via a chemical bond.

According to one preferred embodiment, t and q are independently 0 or 1.

According to one preferred embodiment, Q, T, and Y in formula II are independently selected from a chemical bond, —O—, —SO₂— and —CR^{a}R^{b}—, with the proviso that at least one of Q, T, and Y is present and is —SO₂—. Furthermore, it may be preferred, if R^{a} and R^{b} are, independently of one another, hydrogen or (C₁-C₄)alkyl.

In —CR^{a}R^{b}—, R^{a} and R^{b} are preferably independently selected from hydrogen, (C₁-C₁₂)alkyl, (C₁-C₁₂)alkoxy and (C₆-C₁₈)aryl.

(C₁-C₁₂)alkyl refers to linear or branched saturated hydrocarbon groups having from 1 to 12 carbon atoms. The following moieties are particularly encompassed: (C₁-C₆)alkyl, e.g. methyl, ethyl, n-propyl, isopropyl, n-butyl, sec-butyl, 2- or 3-methylpentyl, as well as (C₇-C₁₂)alkyl, e.g. unbranched heptyl, octyl, nonyl, decyl, undecyl, lauryl, and the singly branched or multi-branched analogs thereof.

The term “C₁-C₁₂-alkoxy” refers to a linear or branched alkyl group having 1 to 12 carbon atoms which is bonded via an oxygen, at any position in the alkyl group, e.g. methoxy, ethoxy, n-propoxy, 1-methylethoxy, butoxy, 1-methyl-propoxy, 2-methylpropoxy or 1,1-dimethylethoxy. (C₃-C₁₂)cycloalkyl refers to monocyclic saturated hydrocarbon radicals having 3 to 12 carbon ring members and particularly comprises (C₃-C₈)cycloalkyl, e.g. cyclopropyl, cyclobutyl, cyclopentyl, cyclohexyl, cycloheptyl, cyclooctyl, cyclopropylmethyl, cyclopropylethyl, cyclopropylpropyl, cyclobutylmethyl, cyclobutylethyl, cyclopentylethyl, -propyl, -butyl, -pentyl, -hexyl, cyclohexylmethyl, -dimethyl, and -trimethyl.

Ar and Ar¹ are independently of one another a (C₆-C₁₈)-arylene group. It may be preferred that, according to a specific embodiment, Ar¹ is an unsubstituted (C₆-C₁₂)arylene group.

It may be preferred that Ar and Ar¹ are independently selected from phenylene, biphenylene and naphthylene groups, and from arylene groups that derive from anthracene, from phenanthrene, or from naphthacene. For examples, Ar and Ar¹ are independently selected from 1,2-phenylene, 1,3-phenylene, 1,4-phenylene, 1,6-naphthylene, 1,7-naphthylene, 2,6-naphthylene and 2,7-naphthylene, 2,7-dihydroxynaphthalene and 4,4′-biphenylene.

In particular, it may be preferred that Ar and Ar¹ are independently selected from phenylene and naphthylene groups, such as independently selected from 1,2-phenylene, 1,3-phenylene, 1,4-phenylene, 1,6-naphthylene, 1,7-naphthylene, 2,6-naphthylene and 2,7-naphthylene, more specifically independently selected from 1,4-phenylene, 1,3-phenylene and naphthylene. Furthermore, according to another embodiment of the present invention Ar and Ar¹ are independently selected from arylene groups that derive from anthracene, from phenanthrene, or from naphthacene. According to still a further embodiment, Ar and Ar¹ are independently selected from 2,7-dihydroxynaphthalene and 4,4′-biphenylene.

It may be preferred if the polyarylene(ether)sulfone according to component A) comprises at least one of the following repeat units IIa to IIo:

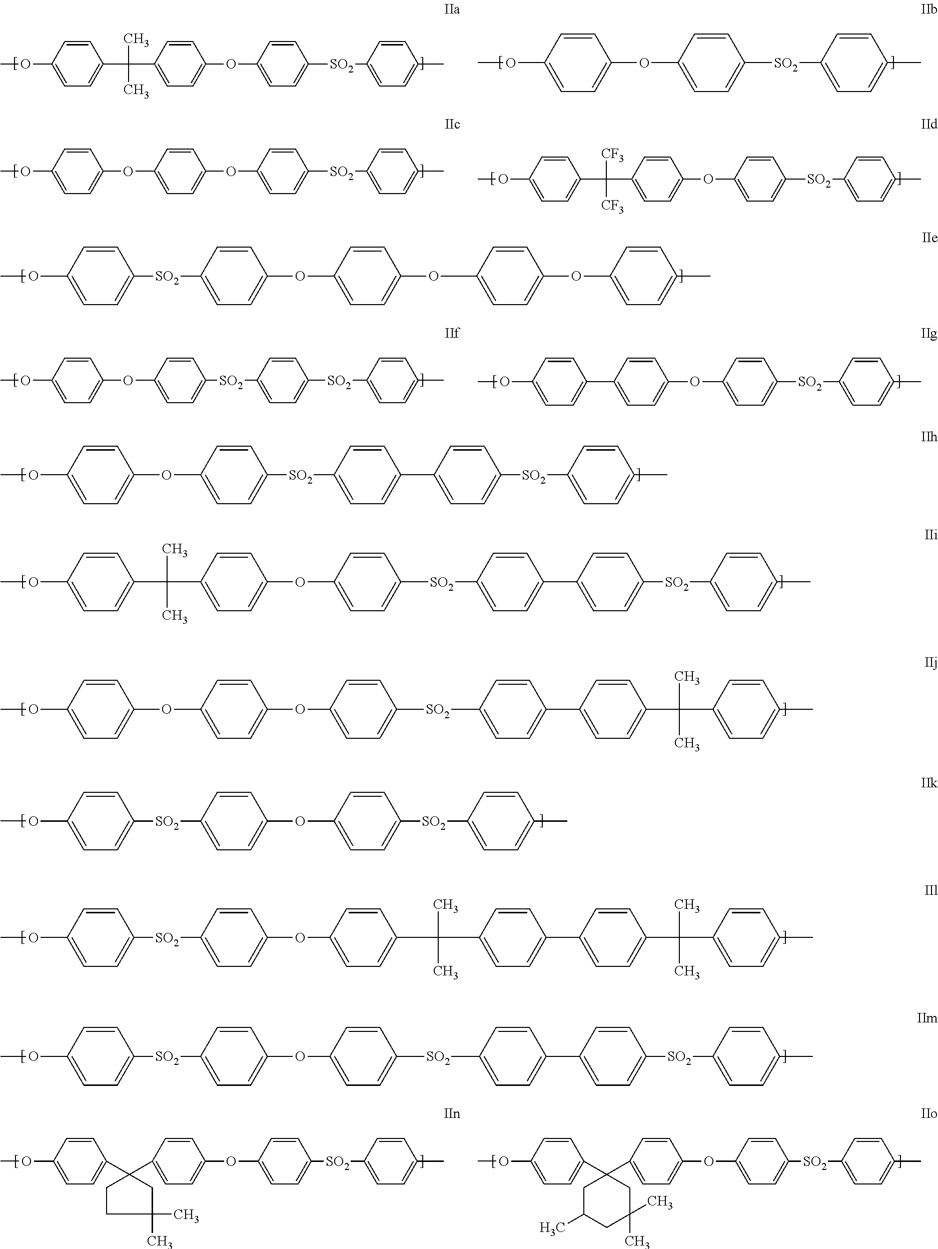

Other repeat units, in addition to the units IIa to IIo that may preferably be present, are those in which one or more 1,4-phenylene units deriving from hydroquinone have been replaced by 1,3-phenylene units deriving from resorcinol, or by naphthylene units deriving from dihydroxynaphthalene.

Units of the general formula II that are particularly preferred are the units IIa, IIg, and/or IIk. According to a specific embodiment, it is particularly preferred that the component A) polyarylene(ether)sulfone is in essence composed of one type of unit of the general formula II, whereby said one type may particularly be selected from IIa, IIg, and IIk.

According to a preferred embodiment, the component A) polyarylene(ether)sulfone is composed of repeat units where Ar is 1,4-phenylene, t is 1, q is 0, T is a chemical bond, and Y is SO₂. This polyarylene(ether)sulfone is also termed polyphenylene sulfone (PPSU) (formula IIg).

According to a further preferred embodiment, the component A) polyarylene(ether)sulfone is composed of repeat units where Ar is 1,4-phenylene, t is 1, q is 0, T is C(CH₃)₂, and Y is SO₂. This polyarylene(ether)sulfone is also termed polysulfone (PSU) (formula IIa).

According to still a further preferred embodiment, the component A) polyarylene(ether)sulfone is composed of repeat units where Ar is 1,4-phenylene, t is 1, q is 0, T and Y are SO₂. This polyarylene(ether)sulfone is also termed polyether sulfone (PESU) (formula IIk).

For the purposes of the present disclosure, abbreviations such as PPSU, PESU, and PSU are in accordance with DIN EN ISO 1043-1:2001.

The amount of component A) present in the inventive composition is 15 to 90% by weight.

According to a preferred embodiment, the amount of component A) is 15 to 85% by weight, in particular 15 to 70% by weight, more specifically 15 to 65% by weight, and even more specifically 15 to 60% by weight of the composition. More specifically, an embodiment uses 15 to 55% by weight, more specifically 15 to 50% by weight, and even more specifically 15 to 45% by weight of component A). According to a very particular embodiment, the amount of component A) is 18 to 83% by weight. In a further preferred embodiment, the amount of component A) is 20 to 75% by weight, in particular 20 to 70% by weight, more specifically 20 to 65% by weight, and even more specifically 20 to 60% by weight of the composition. A very specific embodiment of the invention uses 20 to 55% by weight, more specifically 20 to 50% by weight, and even more specifically 20 to 45% by weight of component A). According to another preferred embodiment, the amount of component A) is 25 to 75% by weight, in particular 25 to 70% by weight, more specifically 25 to 65% by weight, and even more specifically 25 to 60% by weight of the composition. A very specific embodiment of the invention uses 25 to 55% by weight, more specifically 25 to 50% by weight, and even more specifically 25 to 45% by weight of component A). In certain cases, amounts of 25 to 40%, more specifically 25 to 35% by weight of component A) can be preferred.

The weight-average molar masses M_{w} of the polyarylene(ether)sulfones A) of the present invention are preferably from 10,000 to 40,000 g/mol, more specifically from 10,000 to 37,000 g/mol, in particular from 12,000 to 35,000 g/mol, particularly preferably from 14,000 to 33,000 g/mol, determined by means of gel permeation chromatography in dimethylacetamide as solvent against narrowly distributed polymethyl methacrylate as standard. The polyarylene(ether)sulfones A) used according to the invention have a V.N. below 42 ml/g. According to one embodiment, the V.N. is equal to or below 40 ml/g. According to a further embodiment, the V.N. is equal to or below 38 ml/g. The V.N. is measured as 1 wt. % solution in N-methyl-2-pyrrolidone at 25° C. according to ISO 1628.

Production processes that lead to the abovementioned polyarylene(ether)sulfones are known per se to the person skilled in the art and are described by way of example in Herman F. Mark, “Encyclopedia of Polymer Science and Technology”, third edition, volume 4, 2003, chapter “Pol-sulfones” pages 2 to 8, and also in Hans R. Kricheldorf, “Aromatic Polyethers” in: Handbook of Polymer Synthesis, second edition, 2005, pages 427 to 443.

The synthesis of the polyarylene(ether)sulfones can generally be done by polycondensation of appropriate monomers in dipolar-aprotic solvents at elevated temperatures (R. N. Johnson et. al., J. Polym. Sci. A—1 5 (1967) 2375, J. E. McGrath et. al., Polymer 25 (1984) 1827). To achieve the preferred V.N., the molecular weight of the polyarylene(ether)sulfone has to be controlled, which can be done, for example, by monitoring the torque level during the condensation, which requires a calibration curve between the torque level in the reaction mixture and a corresponding final product. Furthermore, by using the general knowledge about adjusting the molecular weight by means of using an appropriate stoichiometric ratio between the monomers during polycondensation, the molecular weight can be controlled such that the needed viscosity of the polyarylene(ether) sulfone is achieved (see, for example McGrath et al. Polym. Eng. Sci. 17, 647 (1977)). Also in this case, a correlation between the molecular weight Mₙ and the V.N. has to be established.

The known polyarylene(ether)sulfones usually have halogen end groups, in particular —F or —Cl, or phenolic OH end groups or phenolate end groups, where the latter can be present as such or in reacted form, in particular in the form of —OCH₃ end groups.

Particular preference is given to the reaction, in aprotic polar solvents and in the presence of anhydrous alkali metal carbonate, in particular sodium carbonate, potassium carbonate, calcium carbonate, or a mixture thereof, very particularly preferably potassium carbonate, between at least one aromatic compound having two halogen substituents and at least one aromatic compound having two functional groups reactive toward abovementioned halogen substituents. One particularly suitable combination is N-methyl-2-pyrrolidone as solvent and potassium carbonate as base.

It is preferable that the polyarylene(ether)sulfones as component A) have either halogen end groups, in particular chlorine end groups, or etherified end groups, in particular alkyl ether end groups, these being obtainable via reaction of the OH or, respectively, phenolate end groups with suitable etherifying agents.

Examples of suitable etherifying agents are monofunctional alkyl or aryl halide, e.g. C₁-C₆-alkyl chloride, C₁-C₆-alkyl bromide, or C₁-C₆-alkyl iodide, preferably methyl chloride, or benzyl chloride, benzyl bromide, or benzyl iodide, or a mixture thereof. For the purposes of the polyarylene(ether)sulfones of component A) preferred end groups are halogen, in particular chlorine, alkoxy, in particular methoxy, aryloxy, in particular phenoxy, or benzyloxy.

The component A) has Cl— or O—CH₃-endgroups and the content of OH or phenolate endgroups is less than 0.05 wt. %, determined by potentiometric titration.

As component B) 5 to 80 wt. % graphite is used. Graphite is a form of carbon as described by way of example in A. F. Hollemann, E. Wiberg, N. Wiberg, “Lehrbuch der anorganischen Chemie” [Textbook of inorganic chemistry], 40 91st-100 t” edn., pp. 701-702. Graphite is composed of planar carbon layers mutually superposed. Graphite can be comminuted by milling. The used graphite can be of natural or synthetic origin and has high crystallinity and low level of impurities, such as SiO₂. The volume average particle size, which can be measured by laser scattering, is in the range of from 0.1 μm to 500 μm, preferably in the range of from 1 μm to 300 μm, more specifically from 5 μm to 250 μm. Furthermore, the thickness of the graphite layers can be determined by electron microscopy. The thickness of the graphite layers determined by electron microscopy is in the range of 0.05 μm to 100 μm, preferably between 0.1 and 50 μm. It is preferred to use graphite with a low content of particles having a volume average particle size below 5 μm, such as equal to or less than 5% of the particles with a volume average particle size of equal to or below 5 μm.

An example for commercially available graphite that can be used as component B) in the inventive compositions is Timrex KS75 from Imerys. Details about the influence of the particle size and the anisotropy of the graphite for the compounding and the electrical properties of compounds are also known from the art (Derieth, T., Kunststoffe 8/2015, p. 82).

For clarification, the graphite component B) used according to the present invention is “normal” graphite—either natural or synthetic. The graphite component B) is not expanded or expandable graphite, also sometimes called exfoliated graphite. Expandable graphite is produced from normal, such as naturally occurring, graphite, wherein the normal graphite flakes are usually treated with an oxidizing acid such as e.g. sulphuric acid or nitric acid, thereby forming graphite-intercalation products. Such products can expand upon influence of heat. According to the present invention the term “graphite” as component B) does not encompass expandable or expanded graphite.

According to a preferred embodiment, the amount of component B) is 10 to 80% by weight, in particular 15 to 80% by weight, more specifically 20 to 80% by weight, and even more specifically 25 to 80% by weight of the composition. More specifically, an embodiment uses 30 to 80% by weight, more specifically 35 to 80% by weight, and even more specifically 40 to 80% by weight of component B). In a further embodiment, the amount of component B) is 45 to 80% by weight, in particular 50 to 80% by weight, more specifically 55 to 80% by weight. A further specific embodiment of the invention uses 10 to 75% by weight, more specifically 10 to 70% by weight, and even more specifically 10 to 65% by weight of component B). According to another preferred embodiment, the amount of component B) is 10 to 75% by weight, in particular 15 to 70% by weight, more specifically 20 to 70% by weight, and even more specifically 25 to 70% by weight of the composition. A very specific embodiment of the invention uses 30 to 70% by weight, more specifically 35 to 70% by weight, and even more specifically 40 to 70% by weight of component B). In certain cases amounts of 45 to 75%, more specifically 50 to 70% by weight of component B) can be preferred.

The inventive compositions comprise 5 to 80 wt. % conductive carbon black as component C). The conductive carbon black used can be any commonly used form of carbon black, wherein various carbon blacks having differences in their structure, surface chemistry and wetting behavior can be used. An example of a suitable product is Ketjenblack 300 commercially available from Akzo. A further example of a suitable carbon black is Printex XE 2 of Orion Engineered Carbons. Also suitable may be Printex® L by Orion Engineered Carbons or Ensaco 250 conductive carbon black from TimCal. Carbon black conducts electrons (F. Camona, Ann. Chim. Fr. 13, 395 (1988)) by virtue of graphitic layers embedded in amorphous carbon. Electricity is conducted within the aggregates composed of carbon black particles and between the aggregates if the distances between the aggregates are sufficiently small. To achieve conductivity while minimizing the amount added, it is preferable to use carbon blacks having an anisotropic structure (G. Wehner, Advances in Plastics Technology, A P T 2005, Paper 11, Katowice 2005). In such carbon blacks, the primary particles associate to give anisotropic structures, the result being that the necessary distances between the carbon black particles for achievement of conductivity are achieved in compounded materials even at comparatively low loading (C. Van Bellingen, N. Probst, E. Grivei, Advances in Plastics Technology, A P T 2005, Paper 13, Katowice 2005). By way of example, the oil absorption of suitable types of carbon black (measured to ASTM D2414-01) is at least 60 ml/100 g, preferably more than 90 ml/100 g. The BET (Brunauer-Emmett-Teller) surface area of suitable products is more than 50 m²/g, preferably more than 60 m²/g (measured to ASTM D3037-89). There can be various functional groups on the surface of the carbon black. The conductive carbon blacks can be prepared by various processes (G. Wehner, Advances in Plastics Technology, APT 2005, Paper 11, Katowice 2005).

According to a preferred embodiment, the amount of component C) is 5 to 70% by weight, in particular 5 to 60% by weight, more specifically 5 to 50% by weight, and even more specifically 5 to 40% by weight, more particularly 5 to 35% by weight, of the composition. More specifically, an embodiment uses 6 to 70% by weight, more specifically 6 to 60% by weight, and even more specifically 6 to 50% by weight of component C). In a further embodiment, the amount of component C) is 6 to 40% by weight. A further specific embodiment of the invention uses 6 to 30% by weight, more specifically 6 to 25% by weight, and even more specifically 6 to 20% by weight of component C). According to another preferred embodiment, the amount of component C) is 7 to 70% by weight, in particular 7 to 60% by weight, more specifically 7 to 50% by weight, and even more specifically 7 to 40% by weight, more particularly 7 to 35% by weight, of the composition.

The inventive compositions comprise 0 to 25 wt. %, preferably 0 to 20 wt. % of carbon nanotubes as component D). According to one aspect of the invention, the compositions comprise carbon nanotubes in an amount of more than 0 to 25 wt %, preferably more than 0 to 20 wt % of component D).

Carbon nanotubes are carbon-containing nanoparticles in which the carbon (mainly) has graphite structure and the individual graphite layers have a tubular arrangement. Nanotubes and their synthesis have been previously disclosed in the literature (for example J. Hu et al., Acc. Chem. Res. 32 (1999), 435-445). For the purposes of the present invention, it is in principle possible to use any type of nanotubes. Carbon nanotubes suitable as component D) preferably have a mean diameter in the range of from 1 to 300 nm. They can be single-wall or multiwall carbon nanotubes, with the nanotubes being present individually or as bundles, for example as bundles in a hexagonal arrangement. Preparation of the carbon nanotubes can be by catalytic chemical vapor deposition at ambient pressure or high pressure, or alternatively via a graphite spark technique in the presence or absence of a catalyst or via a laser vapor deposition technique in the presence of a catalyst. Such techniques are described, for example in Carbon, Volume 32, p. 569 (1994), Nature, Volume 354, p. 56 (1991), and Science, Volume 273, p. 483 (1996). In the case of multiwall carbon nanotubes, the diameter is preferably from 10 to 200 nm. The mean length of the carbon nanotubes can, for example, be in the range from 1 to 1000 μm.

For the purposes of the present invention, multiwalled nanotubes (MWNT) are preferred as component D). Suitable nanotubes can for example be purchased from Applied Sciences Inc. and/or Hyperion Catalysis Int., Cambridge Mass. (USA). See also EP 205 556, EP 969 128, EP 270 666, U.S. Pat. No. 6,844,061, WO 01/89013, U.S. Pat. Nos. 5,651,922 and 5,643,502, WO 01/36536 and WO 00/68299. According to a preferred embodiment, the amount of component D) is 1 to 25% by weight, in particular 1 to 20% by weight, more specifically 1 to 15% by weight, and even more specifically 1 to 10% by weight of the composition. More specifically, an embodiment uses 5 to 25% by weight, more specifically 5 to 20% by weight, and even more specifically 5 to 15% by weight of component D).

According to one specific embodiment, the inventive compositions do not contain a component D) (0% by weight).

According to the present invention, the compositions comprise 0 to 40% by weight, in particular from 0 to 30% by weight, more specifically from 0 to 20% by weight, even more specifically from 0 to 10% by weight, for example from 0 to 5% by weight. of at least one additive (component E)). In one aspect of the present invention, the inventive compositions comprise at least one additive (component E)) in an amount of more than 0 to 40 wt %, preferably more than 0 to 30 wt %, more specifically more than 0 to 20 wt % of component E). It may be preferred according to this aspect, if component E) is present in an amount of more than 0 to 15 wt %, in particular more than 0 to 10 wt %, more specifically more than 0 to 5 wt %.

If present it may be preferable that the composition comprises from 0.01 to 20% by weight, more specifically from 1 to 20% by weight of at least one additive E). It may be more preferred if E) is used in amounts of from 0.01 to 15% by weight, such as from 0.5 to 10% by weight. It may be even more preferred that the inventive composition comprises E) from 0.5 to 8% by weight.

The at least one additive may be selected from for example processing aids, pigments, stabilizers, impact modifiers and may also be a mixture of various additives. Other examples of conventional additives are oxidation retarders, agents to inhibit decomposition caused by heat or by ultraviolet light, lubricants and mold-release agents, dyes and plasticizers, which may be used alone or in any combination with any other additive.

Examples of oxidation retarders and heat stabilizers which can be added to the inventive compositions are halides of metals of group I of the Periodic Table of the Elements, e.g. sodium halides, potassium halides, or lithium halides, examples being chlorides, bromides, or iodides. Zinc fluoride and zinc chloride can also be used. It is also possible to use sterically hindered phenols, hydroquinones, substituted representatives of said group, secondary aromatic amines, if appropriate in combination with phosphorus-containing acids, or to use their salts, or a mixture of said compounds, preferably in concentrations of up to 1% by weight.

Examples of UV stabilizers are various substituted resorcinols, salicylates, benzotriazoles, and benzophenones, the amounts generally used of these being up to 2% by weight.

Examples for lubricants mold-release agents, the amounts of which may generally be up to 2%, preferably up to 1% by weight, are stearyl alcohol, alkyl stearates, and stearamides, and also esters of pentaerythritol with long-chain fatty acids. It is also possible to use dialkyl ketones, such as distearyl ketone. It may be preferred that the inventive composition comprises from 0.1 to 2% by weight, more preferably from 0.1 to 1.75% by weight, particularly preferably from 0.1 to 1.5% by weight, and in particular from 0.1 to 0.9% by weight, of stearic acid and/or of stearates. In principle it is also possible to use other stearic acid derivatives, for example esters of stearic acid.

Stearic acid is preferably produced via hydrolysis of fats. The products thus obtained are usually mixtures composed of stearic acid and palmitic acid. These products therefore have a wide softening range, for example from 50 to 70° C., as a function of the constitution of the product. Preference may be given to using products with more than 20% by weight content of stearic acid, particularly preferably more than 25% by weight. It is also possible to use pure stearic acid (more than 98% by weight).

Component E) can moreover also include stearates. Stearates can be produced either via reaction of corresponding sodium salts with metal salt solutions (e.g. CaCl₂, MgCl₂, aluminum salts) or via direct reaction of the fatty acid with metal hydroxide (see for example Baerlocher Additives, 2005). It is typically preferable to use aluminum tristearate.

Other possible additives are nucleating agents, an example being talc powder. Component E) may include one or more impact modifiers, where the impact modifier may be at least one impact modifying rubber. Rubbers are generally crosslinkable polymers which have elastomeric properties at room temperature.

Preferred rubbers which increase the toughness of compositions usually have two significant features: they comprise an elastomeric fraction which has a glass transition temperature below −10° C., preferably below −30° C., and they contain at least one functional group which can interact with a polyarylene(ether)sulfone. Examples of suitable functional groups are carboxylic acid, carboxylic anhydride, carboxylic ester, carboxamide, carboxamide, amino, hydroxyl, epoxy, urethane and oxazoline groups.

Generally preferred at least one functionalized rubber include functionalized polyolefin rubbers built up from the following components:
d1) from 40 to 99% by weight of at least one alpha-olefin having from 2 to 8 carbon atoms;
d2) from 0 to 50% by weight of a diene;
d3) from 0 to 45% by weight of at least one C₁-C₁₂-alkyl ester of acrylic or methacrylic acid, or mixtures of esters of this type;
d4) from 0 to 40% by weight of at least one ethylenically unsaturated C₂-C₂₀ mono- or dicarboxylic acid or of a functional derivative of an acid of this type;
d5) from 1 to 40% by weight of at least one monomer containing epoxy groups; and
d6) at least one monomer capable of free-radical polymerization.

Examples of suitable at least one alpha-olefin (d1) are ethylene, propylene, 1-butylene, 1-pentylene, 1-hexylene, 1-heptylene, 1-octylene, 2-methylpropylene, 3-methyl-1-butylene and 3-ethyl-1-butylene. Ethylene and propylene may be preferred.

Examples of suitable at least one diene monomer (d2) are conjugated dienes having from 4 to 8 carbon atoms, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricyclodienes, such as 3-methyltricyclo [5.2.1.02.6]-3,8-decadiene, or mixtures of these. Preference is given to 1,5-hexadiene, 5-ethylidenenorbornene and dicyclopentadiene. The diene content can generally be from 0 to 50% by weight, whereby it may be preferred that it is from 0.5 to 50% by weight, whereby it may be particularly preferably from 2 to 20% by weight and more particularly preferably from 3 to 15% by weight, based on the total weight of the olefin polymer.

Examples of suitable at least one ester (d3) are methyl, ethyl, propyl, n-butyl, isobutyl, 2-ethylhexyl, octyl and decyl acrylates and the corresponding methacrylates. Among these, particular preference may be given to methyl, ethyl, propyl, n-butyl and 2-ethylhexyl acrylate and methacrylate.

Instead of the at least one ester (d3), or in addition to these, the olefin polymers may also comprise acid-functional and/or latently acid-functional monomers in the form of at least one ethylenically unsaturated mono- or dicarboxylic acid (d4).

Examples of at least one monomer (d4) are acrylic acid, methacrylic acid, tertiary alkyl esters of these acids, in particular tert-butyl acrylate, and dicarboxylic acids, such as maleic acid and fumaric acid, and derivatives of these acids, and also their half-esters.

For the purposes of the invention, latently acid-functional monomers are those compounds which under the conditions of the polymerization or during incorporation of the olefin polymers into the compositions form free acid groups. Examples of these are anhydrides of dicarboxylic acids having from 2 to 20 carbon atoms, in particular maleic anhydride, and tertiary C1-C12-alkyl esters of the abovementioned acids, in particular tert-butyl acrylate and tert-butyl methacrylate. Ethylenically unsaturated dicarboxylic acids and anhydrides (d4) have the following formulae III and IV:

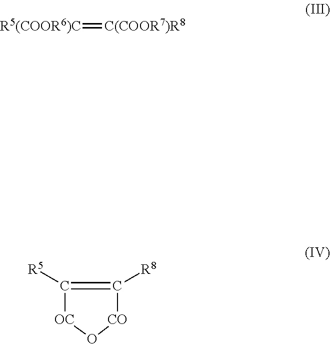

where R⁵, R⁶, R⁷ and R⁸, independently of one another, are H or C₁-C₅-alkyl.
Monomers d5 containing epoxy groups have the following formulae V and VI

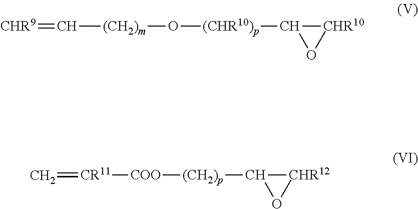

where R⁹, R¹⁰, R¹¹ and R¹², independently of one another, are H or C₁-C₅-alkyl, m is an integer from 0 to 20, and p is an integer from 0 to 10.

R⁵ to R¹² may preferably be hydrogen, m may preferably be 0 or 1 and p may preferably be 1.

Preferred compound (d4) and, respectively, (d5) may be selected from maleic acid, fumaric acid and maleic anhydride and, respectively, alkenyl glycidyl ethers and vinyl glycidyl ether.

Particularly preferred compounds of the formulae III and IV and, respectively, V and VI can be maleic acid and maleic anhydride and, respectively, acrylates and/or methacrylate both of which contain epoxy groups, in particular glycidyl acrylate and glycidyl methacrylate.

Particularly preferred at least one olefin polymer may be those made from 49.9 to 98.9% by weight, in particular from 59.85 to 94.85% by weight, of ethylene, and from 1 to 50% by weight, in particular from 5 to 40% by weight, of an ester of acrylic or methacrylic acid, and from 0.1 to 20.0% by weight, in particular from 0.15 to 15% by weight, of glycidyl acrylate and/or glycidyl methacrylate, acrylic acid and/or maleic anhydride.

Particularly suitable functionalized rubbers may be selected from ethylene-methyl methacrylateglycidyl methacrylate polymer, ethylene-methyl acrylateglycidyl methacrylate polymer, ethylenemethyl acrylate-glycidyl acrylate polymer and an ethylene-methyl methacrylate-glycidyl acrylate polymer and any mixture of these.

Examples of other monomers (d6) are for instance vinyl esters and vinyl ethers and mixtures of these.

The polymers described above may be prepared by processes known per se or accessible to the person skilled in the art by applying the general knowledge, for instance preferably by random copolymerization at high pressure and elevated temperature.

The melt index of the copolymers may generally be from 1 to 80 g/min 10 min (measured at 190° C. and 2.16 kg load).

Furthermore, functionalized ethylene-α-olefin-copolymers like ethylene-propylene-grafted-maleic anhydride or ethylene-1-butene-grafted maleic anhydride can also be used as impact modifiers in the inventive compositions.

Core-shell graft rubbers is another group of suitable impact-modifies that may be used according to the invention. These are graft rubbers which can be prepared in emulsion and composed of at least one hard and one soft constituent. Usually, a hard constituent is at least one polymer with a glass transition temperature of at least 25° C., and usually a soft constituent is at least one polymer with a glass transition temperature of not more than 0° C. These products generally have a structure made from a core (graft base) and from at least one shell (graft), and the structure is typically a result of the sequence of addition of the monomers. The soft constituent generally derives from butadiene, isoprene, at least one alkyl acrylate, at least one alkyl methacrylate or at least one siloxane and, if desired, at least one other comonomer. Suitable siloxane cores may be prepared, for example, starting from cyclic oligomeric octamethyltetrasiloxane or from tetravinyltetramethyltetrasiloxane. These may, for example, be reacted with y-mercaptopropylmethyldimethoxysilane in a ring-opening cationic polymerization, preferably in the presence of sulfonic acids, to give the soft siloxane core. The at least one siloxane may also be crosslinked by, for example, carrying out the polymerization in the presence of at least one silane having at least one hydrolyzable group, such as halo or alkoxy, for example tetraethoxysilane, methyltrimethoxysilane or phenyltrimethoxysilane. Examples of suitable at least one comonomer for this are styrene, acrylonitrile and crosslinking or grafting monomers having more than one polymerizable double bond, for example diallyl phthalate, divinylbenzene, butanediol diacrylate or triallyl (iso) cyanurate. The hard constituent generally derives from styrene, alphamethylstyrene or from copolymers of these, and it may be preferred that the at least one comonomer here is acrylonitrile, methacrylonitrile or methyl methacrylate.

It may be preferred that the at least one core-shell graft rubber comprises a soft core and a hard shell or a hard core, a first soft shell and at least one further hard shell. The incorporation of at least one functional group here, such as carbonyl, carboxylic acid, anhydride, amide, imide, carboxylic ester, amino, hydroxyl, epoxy, oxazoline, urethane, urea, lactam or halobenzyl, may preferably take place by adding at least one suitably functionalized monomer during the polymerization of the final shell.

Examples of suitable functionalized monomers are maleic acid, maleic anhydride, half-esters or diesters, or maleic acid, tert-butyl (meth)acrylate, acrylic acid, glycidyl (meth-)acrylate and vinyloxazoline. The proportion of monomers with functional groups is generally from 0.1 to 25% by weight, whereby it may be preferably from 0.25 to 15% by weight, based on the total weight of the core-shell graft rubber. The weight ratio of soft to hard constituents is generally from 1:9 to 9:1, whereby it may be preferably from 3:7 to 8:2.

Rubbers of this type are known per se or accessible to the person skilled in the art by making use of the general knowledge and are described, for example, in EP-A 208 187.

Thermoplastic polyester elastomers are another group of suitable impact modifiers. For the purposes of the invention, polyester elastomers are segmented copolyether-esters which may comprise long-chain segments generally deriving from poly(alkylene) ether glycols and short-chain segments which may derive from low-molecular weight diols and dicarboxylic acids. Products of this type are known per se or accessible to the person skilled in the art and are described for example in U.S. Pat. No. 3,651,014. Corresponding products are also available commercially as Hytrel® (Du Pont), Amitel® (Akzo) and Pelprene® (Toyobo Co. Ltd.).

According to one specific embodiment, the inventive compositions do not contain a component E) (0% by weight).

One specific embodiment of the present invention relates to a composition comprising
A) 18 to 83% by weight of at least one polyarylene(ether)sulfone, having a Viscosity Number of less than 42 ml/g;
B) 10 to 75% by weight of graphite;
C) 7 to 50% by weight of a conductive carbon black;
D) 0 to 25 wt.-% of carbon nanotubes; and
E) 0 to 40% by weight of at least one additive;
wherein the sum of % by weight of the components of the composition is 100% by weight.

A further embodiment of the present invention relates to a composition comprising
A) 15 to 79% by weight of at least one polyarylene(ether)sulfone, having a Viscosity Number of less than 42 ml/g;
B) 15 to 79% by weight of graphite;
C) 5 to 50% by weight of a conductive carbon black;
D) 1 to 25 wt.-% of carbon nanotubes; and
E) 0 to 40% by weight of at least one additive;
wherein the sum of % by weight of the components of the composition is 100% by weight.

A further embodiment of the present invention relates to a composition comprising
A) 25 to 55% by weight of at least one polyarylene(ether)sulfone, having a Viscosity Number of less than 42 ml/g;
B) 40 to 70% by weight of graphite;
C) 5 to 35% by weight of a conductive carbon black;
D) 0 to 25 wt.-% of carbon nanotubes; and
E) 0 to 30% by weight of at least one additive;
wherein the sum of % by weight of the components of the composition is 100% by weight.

A further specific embodiment of the present invention relates to a composition consisting of
A) 15 to 90% by weight of at least one polyarylene(ether)sulfone, having a Viscosity Number of less than 42 ml/g;
B) 5 to 80% by weight of graphite;
C) 5 to 80% by weight of a conductive carbon black;
D) 0 to 25 wt.-% of carbon nanotubes; and
E) 0 to 40% by weight of at least one additive;
wherein the sum of % by weight of the components of the composition is 100% by weight.

A further embodiment of the present invention relates to a composition consisting of
A) 18 to 83% by weight of at least one polyarylene(ether)sulfone, having a Viscosity Number of less than 42 ml/g;
B) 10 to 75% by weight of graphite;
C) 7 to 50% by weight of a conductive carbon black;
D) 0 to 25 wt.-% of carbon nanotubes; and
E) 0 to 40% by weight of at least one additive;
wherein the sum of % by weight of the components of the composition is 100% by weight.

Still a further embodiment of the present invention relates to a composition consisting of
A) 15 to 79% by weight of at least one polyarylene(ether)sulfone, having a Viscosity Number of less than 42 ml/g;
B) 15 to 79% by weight of graphite;
C) 5 to 50% by weight of a conductive carbon black;
D) 1 to 25 wt.-% of carbon nanotubes; and
E) 0 to 40% by weight of at least one additive;
wherein the sum of % by weight of the components of the composition is 100% by weight.

Still a further embodiment of the present invention relates to a composition consisting of
A) 25 to 55% by weight of at least one polyarylene(ether)sulfone, having a Viscosity Number of less than 42 ml/g;
B) 40 to 70% by weight of graphite;
C) 5 to 35% by weight of a conductive carbon black;
D) 0 to 25 wt.-% of carbon nanotubes; and
E) 0 to 30% by weight of at least one additive;
wherein the sum of % by weight of the components of the composition is 100% by weight

Preparation of the compositions can be done by processes that are generally known in the art. In particular, the inventive compositions are obtained by melt-compounding the respective components. The person skilled in the art is familiar with melt-compounding per se. Consequently, the present invention also relates to a process for the preparation of a composition comprising A), B) and C), and, if applicable any of the optional components as defined herein, comprising the step of ii) melt-compounding the components. For example, the compositions can be prepared by extrusion. More particularly, the process comprises the steps of i) feeding the components to a melt compounding device and ii) melt-compounding the components.

More specifically, the components are feed to melt mixing (=compounding) devices like extruders (single- or twin-screw), Brabender-mixers or Banburry-mixers or kneaders. In the respective melt-mixing device, the components are mixed. Then, the formed composition may be extruded.

After extrusion the strand is typically cooled and pelletized to obtain pellets or granules.

The components of the inventive composition can be added in any desired sequence. The order of dosing the individual components into the mixing device can be varied, e.g. any two or optionally three of the components can be pre-mixed or all components can be mixed together.

For the product performance a homogeneous mixing is important. To achieve this, generally mixing times from 0.1 to 30 minutes are appropriate. The compounding is preferably carried out at temperatures of at least 300, preferably at least 350° C. According to one embodiment, the temperature during compounding is held from 300° C. to up to 420° C., more preferably 310° C. to 420° C., more specifically 350° C. to 420° C., in particular 350° C. to 380° C. Furthermore, after compounding in an extruder for example, the obtained strands are usually cooled and can be further processed, e.g. pelletized.

Surprisingly, the compositions according to the invention show an excellent combination of mechanical properties and high electrical conductivity making them particularly suitable e.g. for use in bipolar plates. In addition thereto, the inventive compositions offer good chemical resistance, thermal conductivity and improved processability, which is of importance in the production of bipolar plates for fuel cells or electrolysis units.

The inventive composition can advantageously be used for the manufacture of a fiber, film, foam or shaped article. According to a further aspect, the present invention relates to a fiber, film or shaped article comprising the composition as described herein.

Due to the mechanical properties and good thermal and electrical conductivity, the inventive composition is generally particularly suitable for producing components for electric or electronic devices. As the inventive composition has a high temperature resistance and good chemical resistance, it is specifically suitable for the production of components for electric or electronic devices, which are exposed to elevated temperatures and/or chemicals. These can be industry items such as in the vehicle sector e.g. in automobiles or planes.

Generally, the inventive compositions are suitable to be used in bipolar plates. Consequently, a further aspect of the present invention relates to bipolar plates comprising the composition as described herein.

### EXAMPLES

The examples below provide further explanation of the invention, but do not restrict the same. Compounding was done using a twin-screw extruder (Rheomex PTW 25/42p, ThermoFisher), the barrel temperatures were set to keep the melt temperature below 400° C. Moulding of the test samples was done at a melt temperature of 410° C. and a mold temperature of 200° C.

The resistivity of the injection molded samples was measured at 4 different contact pressures (5, 10, 20 and 30 bar). For each contact pressure 4 different currents (0.5 A, 1 A, 1.5 A, 2 A) were used and the necessary voltage was measured. The resistivity was determined as the slope of the best fit line. Mechanical testing was done according to DIN EN ISO 178:2010+A1:2013 in a 3-point bending machine (Instron 5565). For each compound 5 specimen were tested.

The thermal conductivity was measured according to DIN EN ISO 22007-4 using a NETZSCH LFA 457 MicroFlash. The through-plane heat conductivity was determined.

The solution viscosity of the polyarylene(ether) sulfones was determined using a solution of 0.01 g/ml in N-methyl-2-pyrrolidone at 25° C.

Component A1: As component A a polyethersulfonePESU having a viscosity number of 49.0 ml/g was used. The used product had 0.19 wt.-% Cl-endgroups (elemental analysis) and 0.23 wt.-% OCH₃-endgroups (¹H-NMR). The amount of OH-endgroups was below the detection limit (<0.02 wt. %).

Component A2: As component A a polyethersulfone PESU having a viscosity number of 41.2 ml/g was used. The used product had 0.26 wt.-% Cl-endgroups (elemental analysis) and 0.34 wt.-% OCH₃-endgroups (¹H-NMR). The amount of OH-endgroups was below the detection limit (<0.02 wt. %).

Component A3: As component A a polyphenylenesulfone PPSU having a viscosity number of 49.0 ml/g was used. The amount of OH-endgroups was below the detection limit (<0.02 wt. %).

Component A4: As component A a polyphenylenesulfone PPSU having a viscosity number of 40.2 ml/g was used. The amount of OH-endgroups was below the detection limit (<0.02 wt. %).

Component B1: As component B graphite Timrex KS75 from Imerys was used.

Component C1: As component C carbon black Printex XE 2 of Orion Engineered Carbons was used.

TABLE 1

| | V1 | V2 | 3 | 4 | V5 | V6 | 7 | 8 | 9 | Ref |
|---|---|---|---|---|---|---|---|---|---|---|
| component A = | 35 | 30 | — | — | — | — | — | — | — | |
| A1 [wt %] | | | | | | | | | | |
| component A = | — | — | 30 | 28 | — | — | — | — | — | |
| A2 [wt %] | | | | | | | | | | |
| component A = | — | — | — | — | 35 | 30 | — | — | — | |
| A3 [wt %] | | | | | | | | | | |
| component A = | — | — | — | — | — | — | 35 | 30 | 28 | |
| A4 [wt %] | | | | | | | | | | |
| component B = | 58.5 | 63 | 63 | 64.8 | 58.5 | 63 | 58.5 | 63 | 64.8 | |
| B1 [wt %] | | | | | | | | | | |
| component C = | 6.5 | 7 | 7 | 7.2 | 6.5 | 7 | 6.5 | 7 | 7.2 | |
| C1 [wt %] | | | | | | | | | | |
| bending | 17.5 | —* | 19.1 | 19.9 | 14.4 | —* | 14.3 | 15.3 | 15.7 | — |
| modulus [GPa] | | | | | | | | | | |
| bending | 67 | — | 69 | 71 | 63 | — | 62 | 66 | 67 | — |
| strength [MPa] | | | | | | | | | | |
| bending [%] | 0.8 | — | 0.9 | 0.8 | 0.9 | — | 0.8 | 0.7 | 0.7 | — |
| resistivity | 670 | — | 365 | 310 | 650 | — | 350 | 108 | 69 | — |
| [mΩcm²] | | | | | | | | | | |
| thermal. cond. | 12.5 | — | 12.4 | 13.4 | 13.6 | — | 14.1 | 14.7 | 14.9 | 10.0 |
| [W/m*K] | | | | | | | | | | |

—*= no molding possible

The inventive compositions have a good combination of mechanical properties and low resistivity. Surprisingly, these compounds outperform PPS-compounds of the same composition (30 PPS/63 graphite/7 Carbon black; Reference) regarding their thermal conductivity. Furthermore, the effect of the viscosity number of component A) on the overall properties of the compositions is very surprising. For example, the resistivity is very high when using polyethersulfones having higher V.N. (see V1, V5), making such compositions unsuitable for certain applications such as the use in bipolar plates.

1.-17. (canceled)

18. A composition comprising
A) 15 to 90% by weight of at least one polyarylene(ether)sulfone, having a Viscosity Number of less than 42 ml/g;
B) 5 to 80% by weight of graphite;
C) 5 to 80% by weight of a conductive carbon black;
D) 0 to 25 wt.-% of carbon nanotubes; and
E) 0 to 40% by weight of at least one additive;
wherein the sum of % by weight of the components of the composition is 100% by weight.

19. The composition of claim 18, comprising 15 to 85% by weight of component A).

20. The composition of claim 19, comprising 10 to 75% by weight of component B).

21. The composition of claim 20, comprising 5 to 50% by weight of component C).

22. The composition of claim 81, comprising 15 to 79% by weight of component A).

23. The composition of claim 22, comprising 15 to 75% by weight of component B).

24. The composition of claim 23, comprising 5 to 50% by weight of component C).

25. The composition of claim 24, comprising 1 to 25% by weight of component D).

26. The composition of claim 18, wherein the Viscosity Number of component A) is in a range of 38 ml/g to 41 ml/g.

27. The composition of claim 18, wherein component A) is one or more of PPSU, PESU and PSU.

28. A process for the manufacture of a composition according to claim 18, comprising melt-compounding the components.

29. The process of claim 28, wherein the temperature during the melt-compounding is at least 350° C.

30. A composition obtained by the process of claim 28.

31. A use of the composition according to claim 18 in the manufacture of a fiber, film or shaped article.

32. A use of the composition according to claim 18 in the manufacture of a bipolar plate.

33. A fiber, film or shaped article comprising the composition according to claim 18.

34. A bipolar plate comprising the composition according to claim 18.
